(19) United States
(12) Patent Application Publication
(10) Pub. No.: US 2026/0309906 A1
(43) Pub. Date: Oct. 8, 2026

(54) LIGHT-EMITTING STRUCTURE, DISPLAY APPARATUS, AND CONTROL METHOD THEREFOR

(71) Applicants: Beijing BOE Display Technology Co., Ltd., Beijing (CN); BOE Technology Group Co., Ltd., Beijing (CN)

(72) Inventors: Miao LIU, Beijing (CN); Yu ZHANG, Beijing (CN); Bochang WANG, Beijing (CN)

(21) Appl. No.: 19/483,162

(22) PCT Filed: Apr. 23, 2024
(86) PCT No.: PCT/CN2024/089333

§ 371 Date: Nov. 10, 2025

(30) Foreign Application Priority Data
May 25, 2023 (CN) 202310605824.0

(51) Int. Cl. F21V 8/00

(52) U.S. Cl. CPC G02B 6/0055; G02B 6/0068

(57) ABSTRACT

Disclosed is a light-emitting structure. The light-emitting structure includes a light guide member, wherein the light guide member is ring-shaped and has a light-emitting surface and a reflective surface that are opposite to each other in a thickness direction, the reflective surface having an arc-surfaced region; the light guide member is further provided with a mounting groove that is on one side of the arc-surfaced region in a radial direction of the light guide member and extends in a circumferential direction of the light guide member; and a thickness of the light guide member in the arc-surfaced region decreases progressively in a direction away from the mounting groove; and a light source, disposed in the mounting groove, wherein a light-emitting side of the light source faces the arc-surfaced region.

### CROSS-REFERENCE TO RELATED APPLICATION

This application is a U.S. national phase application based on PCT/CN2024/089333, filed on Apr. 23, 2024, which claims priority to Chinese Patent Application No. 202310605824.0, filed on May 25, 2023 and entitled “LIGHT-EMITTING STRUCTURE, DISPLAY APPARATUS, AND CONTROL METHOD THEREFOR”, both of which are incorporated by reference herein.

### TECHNICAL FIELD

The present disclosure relates to the field of display technologies, and in particular, relates to a light-emitting structure, a display apparatus, and a control method therefor.

### BACKGROUND

With the continuous improvement of people's demands for electronic products, functions of electronic products are being constantly innovated, and so are their forms. When displaying an image, an electronic product ensures the brightness of the image on the electronic product based on reflection of natural light. However, when the natural light is insufficient, it is easy to cause the display effect of the electronic product to deteriorate, which in turn affects the display effect of the electronic product.

It should be noted that information disclosed in the background is used merely for a better understanding of the background of the present disclosure, and therefore may include information that does not constitute the prior art known to those of ordinary skill in the art.

### SUMMARY

The present disclosure aims to provide a light-emitting structure, a display apparatus, and a control method therefor.

According to one aspect of the present disclosure, a light-emitting structure is provided. The light-emitting structure includes:
a light guide member, wherein the light guide member is ring-shaped and has a light-emitting surface and a reflective surface that are opposite to each other in a thickness direction, the reflective surface having an arc-surfaced region; the light guide member is further provided with a mounting groove that is on the side of the arc-surfaced region in the radial direction of the light guide member and extends in the circumferential direction of the light guide member; and the thickness of the light guide member in the arc-surfaced region decreases progressively in a direction away from the mounting groove; and
a light source, disposed in the mounting groove, wherein a light-emitting side of the light source faces the arc-surfaced region.

In some embodiments, the reflective surface further has a planar region on the side of the arc-surfaced region close to the mounting groove, and the planar region and the arc-surfaced region being continuous in the radial direction of the light guide member.

In some embodiments, the reflective surface has a first support region that is on the side of the arc-surfaced region in the radial direction of the light guide member, and the mounting groove is provided at a position of the light guide member corresponding to the first support region.

In some embodiments, the reflective surface has a second support region, the second support region being disposed on one side of the arc-surfaced region away from the first support region.

In some embodiments, the mounting groove is disposed on one side of the arc-surfaced region close to an outer annular surface of the light guide member.

In some embodiments, a groove opening of the mounting groove faces away from the light-emitting surface; and the light-emitting structure further includes a light-shielding layer, the light-shielding layer being attached to the light-emitting surface, and an orthographic projection of the light source on the light-emitting surface being within an orthographic projection of the light-shielding layer on the light-emitting surface.

In some embodiments, the light source includes at least one light strip; the light strip including sub-light strips in three colors: red, green, and blue.

In some embodiments, the mounting groove is a ring-shaped groove, and a plurality of partitions are arranged at intervals in the ring-shaped groove; and the light source includes a plurality of light strips, one of the plurality of light strips is provided between every two adjacent partitions.

In some embodiments, the mounting groove includes a plurality of arc-shaped grooves arranged at intervals along the circumferential direction of the light guide member; and the light source includes a plurality of light strips in one-to-one correspondence with the arc-shaped grooves; wherein each of the plurality of light strips is fixed in a corresponding arc-shaped groove.

In some embodiments, the light-emitting structure further includes a diffuser film, the diffuser film being attached to the light-emitting surface.

In some embodiments, the light-emitting structure further includes a first reflection layer, wherein the first reflection layer is attached to the reflective surface of the light guide member, and an orthographic projection of the first reflection layer on the reflective surface of the light guide member covers the arc-surfaced region.

According to one aspect of the present disclosure, a display apparatus is provided. The display apparatus includes: a display screen and the light-emitting structure according to the foregoing aspect, wherein the display screen is disposed on one side of the light guide member close to the reflective surface.

In some embodiments, the display apparatus further includes a glass cover plate, the glass cover plate being disposed in a region encircled by the light guide member.

In some embodiments, the display apparatus further includes a glass cover plate, wherein the glass cover plate is provided with a protrusion and a step surface forming the protrusion, the protrusion being disposed in a region encircled by the light guide member, and the step surface being supported on the light-emitting structure.

In some embodiments, the display screen includes a display module, a top bezel, and a side bezel, wherein

the top bezel has a ring-shaped structure and is disposed on a side where the reflective surface of the light guide member is located, and a surface of the top bezel facing the light guide member is provided with a second reflection layer; the side bezel has a cylindrical structure and is fixedly connected to an edge of the top bezel; and the display module is disposed in a region encircled by the side bezel.

In some embodiments, the reflectivity of the glass cover plate is greater than or equal to 30% and less than or equal to 70%.

In some embodiments, the display apparatus further includes an RGB converter and an adapter board, wherein
the RGB converter is electrically connected to the adapter board and is electrically connected to the display screen, and the adapter board is electrically connected to the light source; and
the RGB converter is configured to acquire display information of the display screen, and determine corresponding RGB information based on the display information, and the adapter board is configured to acquire the RGB information, determine a corresponding electrical parameter based on the RGB information, and control the light source to emit light based on the electrical parameter.

According to one aspect of the present disclosure, a control method for a display apparatus is provided, applied to the display apparatus according to the foregoing aspect, wherein the control method includes:

acquiring display information of the display screen, and adjusting an emission color of the light source of the light-emitting structure based on the display information.

According to one aspect of the present disclosure, a control method for a display apparatus is provided, applied to the display apparatus including the RGB converter and the adapter board according to the foregoing aspect, wherein the control method includes:
acquiring, by the RGB converter, the display information, determining the corresponding RGB information based on the display information, and outputting the RGB information to the adapter board; and
acquiring, by the adapter board, the RGB information, and determining the corresponding electrical parameter based on the RGB information, to adjust the emission color of the light source of the light-emitting structure based on the electrical parameter.

It should be understood that the above general descriptions and the following detailed descriptions and only exemplary and illustrative, and cannot limit the present disclosure.

### BRIEF DESCRIPTION OF DRAWINGS

The accompanying drawings herein are incorporated into and constitute a part of the description, illustrate embodiments conforming to the present disclosure, and together with the description serve to explain the principles of the present disclosure. Apparently, the accompanying drawings in the following description show merely some embodiments of the present disclosure, and those of ordinary skill in the art may still derive other drawings from these accompanying drawings without creative efforts.

FIG. 1 illustrates a schematic bottom structural diagram of a light-emitting structure according to some embodiments of the present disclosure.

FIG. 2 illustrates a schematic diagram of a sectional structure of the light-emitting structure shown in FIG. 1 along a line O—O.

FIG. 3 is an enlarged schematic structural diagram of a region A of a display apparatus shown in FIG. 2.

FIG. 4 illustrates a schematic diagram of a sectional structure of another light-emitting structure according to some embodiments of the present disclosure.

FIG. 5 is an enlarged schematic structural diagram of a region A of a display apparatus shown in FIG. 4.

FIG. 6 illustrates a schematic bottom structural diagram of another light-emitting structure according to some embodiments of the present disclosure.

FIG. 7 illustrates a schematic diagram of a sectional structure of the light-emitting structure shown in FIG. 6 along a line O—O.

FIG. 8 is an enlarged schematic structural diagram of a region A of a display apparatus shown in FIG. 7.

FIG. 9 illustrates a schematic diagram of a sectional structure of a display apparatus according to some embodiments of the present disclosure.

FIG. 10 illustrates a schematic diagram of a sectional structure of another display apparatus according to some embodiments of the present disclosure.

FIG. 11 is an enlarged schematic structural diagram of a partial region of the display apparatus shown in FIG. 9.

FIG. 12 illustrates a schematic diagram of a sectional structure of still another display apparatus according to some embodiments of the present disclosure.

FIG. 13 illustrates a schematic diagram of a sectional structure of yet another display apparatus according to some embodiments of the present disclosure.

FIG. 14 is an enlarged schematic structural diagram of a partial region of the display apparatus shown in FIG. 13.

FIG. 15 illustrates a schematic diagram of a back structure of a display apparatus according to some embodiments of the present disclosure.

FIG. 16 illustrates a schematic flowchart of a control method for a display apparatus according to some embodiments of the present disclosure.

### REFERENCE NUMERALS

10, display apparatus;

1, light-emitting structure; 2, display screen; 3, glass cover plate; 4, RGB converter; 5, adapter board;

11, light guide member; 12, light source; 13, diffuser film; 14, first reflection layer; 15, light-shielding layer;

111, reflective surface; 112, light-emitting surface; 113, mounting groove; 114, arc-surfaced region; 115, first support region; 116, second support region; 117, partition;

21, display module; 22, top bezel; 23, side bezel; 24, second reflection layer;

31, protrusion; and 32, step surface.

### DETAILED DESCRIPTION

Example embodiments are described below in further detail with reference to the accompanying drawings. However, the example embodiments can be implemented in a plurality of forms and should not be construed as being limited to the embodiments described herein. In contrast, these embodiments are provided such that the present disclosure is comprehensive and complete, and fully conveys the concept of the example embodiments to those skilled in the art. The same reference sign denotes the same or similar structure in the drawings, and thus, detailed descriptions thereof are omitted. In addition, the accompanying drawings are merely exemplary illustrations of the present disclosure, and are not necessarily drawn to scale.

Although relative terms such as “upper” and “lower” are used in the description to describe the relative relationship of one component with respect to another component, as shown in the figures, these terms are used in the description only for convenience, for example, based on the exemplary directions shown in the figures. It is understandable that if an apparatus shown in the figures is turned upside down, the described “upper” component becomes a “lower” component. When a structure is “on” another structure, it may mean that the structure is integrally formed on the another structure, or that the structure is “directly” provided on the another structure, or that the structure is “indirectly” provided on the another structure via still another structure.

The terms “a,” “an,” “this,” “the,” and “at least one” are used to indicate the presence of one or more elements/components and the like. The terms “include” and “have” are used to indicate the meaning of including in an open manner, and indicate that there may be other elements/components and the like in addition to the listed elements/components and the like. The terms “first,” “second,” and “third” are used only as markers and are not used as restrictions on the quantity of described objects.

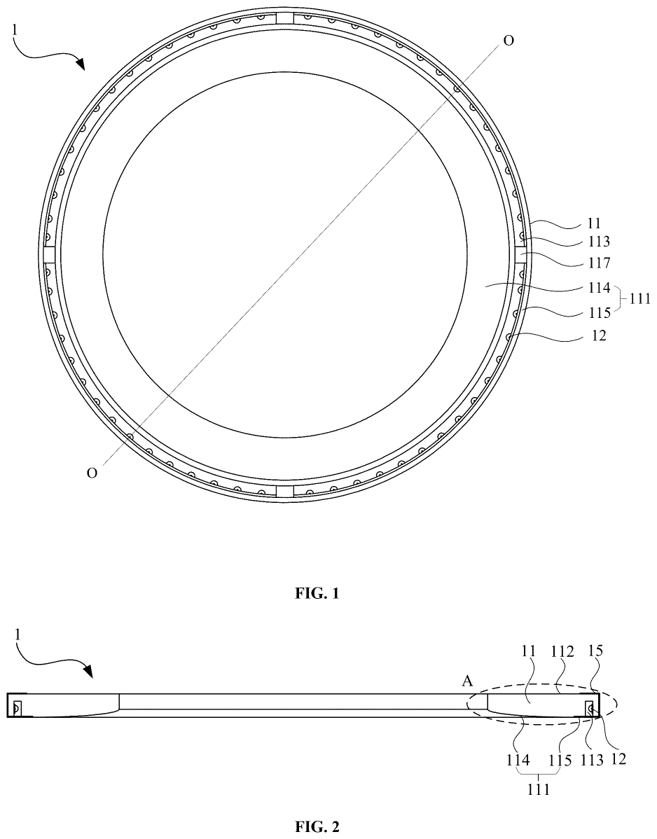

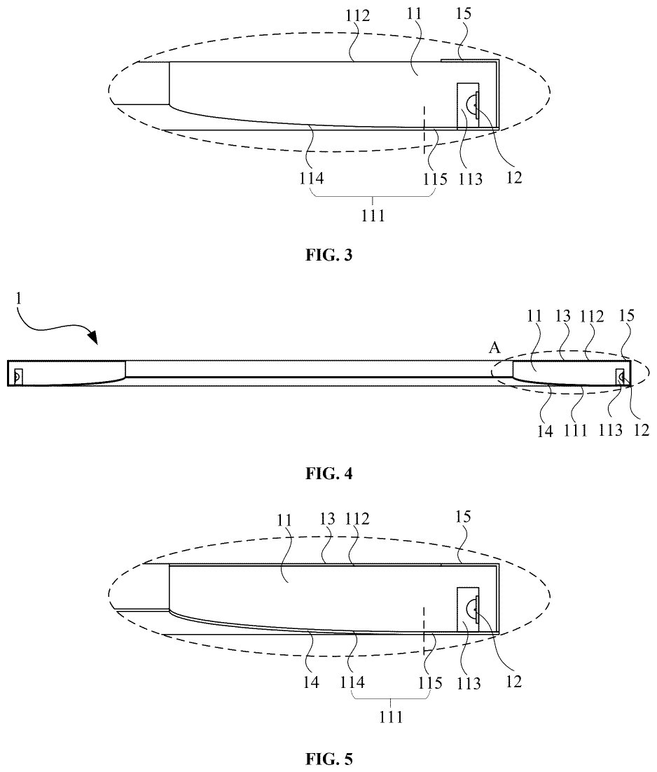

FIG. 1 illustrates a schematic bottom structural diagram of a light-emitting structure 1 according to some embodiments of the present disclosure. FIG. 2 illustrates a schematic diagram of a sectional structure of a light-emitting structure 1 according to some embodiments of the present disclosure. FIG. 3 illustrates an enlarged schematic structural diagram of a region A of the light-emitting structure 1 shown in FIG. 2. As shown in FIG. 1, FIG. 2, and FIG. 3, the light-emitting structure 1 includes: a light guide member 11 and a light source 12. The light guide member 11 is ring-shaped and has a light-emitting surface 112 and a reflective surface 111 that are opposite to each other in the thickness direction. The reflective surface 111 of the light guide member 11 has an arc-surfaced region 114. The light guide member 11 further has a mounting groove 113 that is on the side of the arc-surfaced region 114 in the radial direction of the light guide member 11 and extends in the circumferential direction of the light guide member 11. The thickness of the light guide member 11 in the arc-surfaced region 114 decreases progressively in the direction away from the mounting groove 113. The light source 12 is disposed in the mounting groove 113, and the light-emitting side of the light source 12 faces the arc-surfaced region 114.

In the embodiments of the present disclosure, because the light source 12 is embedded in the light guide member 11, collision of the light source 12 is avoided, and fixation of the light source 12 is facilitated. However, when the light source 12 emits light, the thickness of the light guide member 11 on the light-emitting side of the light source 12 decreases progressively in the direction away from the light source 12, such that when the reflective surface 111 of the light guide member 11 performs total reflection on light beams in the light guide member 11, the mixing effect of the light beams can be ensured. Therefore, the distribution uniformity of the light beams in the radial direction of the light guide member 11 is ensured, thereby improving brightness uniformity. Moreover, the ring-shaped light-emitting structure 1 is provided, such that the light-emitting structure 1 can encircle a display region of a display screen 2 conveniently. Therefore, while a material of the light guide member 11 is saved, it is ensured that the overall brightness of the display screen 2 when displaying an image can be improved effectively, thereby improving the display effect.

The material of the light guide member 11 may be transparent plexiglass. Alternatively, another material may be selected, provided that the color of a light beam emitted from the light guide member 11 is not affected. The light guide member 11 may have a structure of a circular ring as shown in FIG. 1, or may have a structure of a polygonal ring (for example, a structure of a square ring, a structure of a rectangular ring, or a structure of an orthohexagonal ring). When the light guide member 11 has the structure of a circular ring, the radial direction of the light guide member 11 refers to the radial direction of the circular ring. When the light guide member 11 has the structure of a polygonal ring, the radial direction of the light guide member 11 for each side refers to the direction perpendicular to the side.

For the mounting groove 113 and the arc-surfaced region 114 included in the light guide member 11, as shown in FIG. 1 or FIG. 3, the arc-surfaced region 114 may be disposed on the side of the mounting groove 113 close to an inner annular surface of the light guide member 11. Alternatively, the arc-surfaced region 114 may be disposed on the side of the mounting groove 113 close to an outer annular surface of the light guide member 11. For the reflective surface 111 having the arc-surfaced region 114, the plane angle of a light beam emitted by the light source 12 being 82 degrees is used as an example. In this case, the solid angle of the light beam emitted by the light source 12 may be determined to be 5.4 degrees according to the following relation. Furthermore, via optical effect simulation in combination with the above-described light guide member 11 having the arc-surfaced region 114, it may be obviously determined that the brightness of the light-emitting structure 1 is more uniform.

$$ω = 4 π {sin}^{2} ( a / 2 )$$

In the foregoing formula, α denotes the plane angle of the light beam emitted by the light source 12, and ω denotes the solid angle of the light beam emitted by the light source 12.

In some embodiments, the reflective surface 111 further has a planar region on the side of the arc-surfaced region 114 close to the mounting groove 113, and the planar region and the arc-surfaced region 114 are continuous in the radial direction of the light guide member 11. After being emitted from the light source 12, the light beam propagates in a conical range. For a position on the reflective surface 111 of the light guide member 11 close to the light source 12, by providing the planar region, the incidence angle of the light beam in the planar region can be increased than in the arc-surfaced region 114. Therefore, the occurrence of the light beam being emitted from the light guide member 11 is reduced to improve the utilization of the light beam.

The dimension of the planar region in the radial direction of the light guide member 11 may be determined based on a gap between the light-emitting side of the light source 12 and a groove wall in the mounting groove 113 opposite to the light-emitting side. If the gap is relatively large, the dimension of the planar region in the radial direction of the light guide member 11 may be designed to be slightly smaller. If the gap is relatively small, the dimension of the planar region in the radial direction of the light guide member 11 may be designed to be slightly larger.

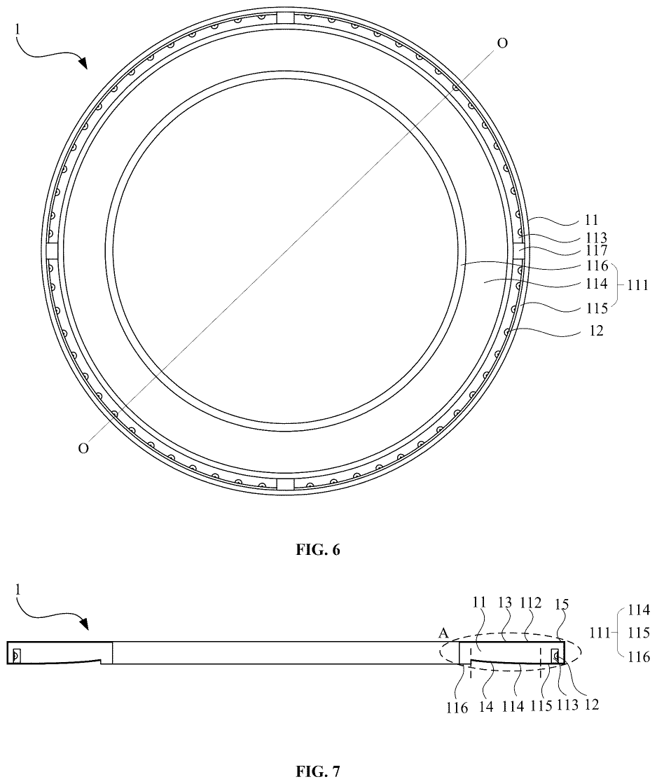

In some embodiments, as shown in FIG. 4 and FIG. 5, the light-emitting structure 1 further includes a diffuser film 13, and the diffuser film 13 fits the light-emitting surface 112. In this way, the light emitted from the light-emitting surface 112 of the light guide member 11 may be diffused by the diffuser film 13, to improve the uniformity of the light beam emitted from the light-emitting surface 112, thereby improving the light-emitting effect of the light-emitting structure 1.

The diffuser film 13 may be formed via spraying, printing, or etching.

Optionally, the haze of the diffuser film 13 is greater than or equal to 76% and less than or equal to 84%. For example, the haze of the diffuser film 13 is 76%, 78%, 80%, 82%, 84%, or the like.

Optionally, the light transmittance of the diffuser film 13 is greater than or equal to 88% and less than or equal to 96%. For example, the light transmittance of the diffuser film 13 is 87%, 90%, 93%, or 96%.

In some embodiments, as shown in FIG. 4 and FIG. 5, the light-emitting structure 1 further includes a first reflection layer 14; the first reflection layer 14 fits the reflective surface 111 of the light guide member 11; and an orthographic projection of the first reflection layer 14 on the reflective surface 111 of the light guide member 11 covers the arc-surfaced region 114. In this case, a light beam emitted along the reflective surface 111 of the light guide member 11 can be re-incident on the light guide member 11 under the reflection of the first reflection layer 14, to improve the utilization efficiency of the light beam emitted by the light source 12, and improve the luminous brightness of the light-emitting structure 1. The first reflection layer 14 may be formed via spraying, printing, or etching.

In the embodiments of the present disclosure, the light guide member 11 is supported on the display screen 2. In view of this, as shown in FIG. 3 or FIG. 5, the reflective surface 111 of the light guide member 11 has a first support region 115 that is on the side of the arc-surfaced region 114 in the radial direction of the light guide member 11, such that the first support region 115 is in contact with the display screen 2 to achieve support of the light guide member 11 on the display screen 2.

The first support region 115 may be fixed to the display screen 2 via an adhesive (for example, a double-sided tape), to achieve fixation of the light guide member 11 on the display screen 2. The first support region 115 may be disposed on the side of the arc-surfaced region 114 close to the mounting groove 113, or the first support region may be disposed on the side of the arc-surfaced region 114 away from the mounting groove 113, which is not limited in the embodiments of the present disclosure.

In addition, when the first support region 115 is disposed on the side of the arc-surfaced region 114 close to the mounting groove 113, the mounting groove 113 may be provided at a position on the light guide member 11 corresponding to the first support region 115. Moreover, with reference to the above-described arrangement of the planar region on the reflective surface 111 of the light guide member 11, the first support region 115 may be provided as a planar structure to form the planar region. In this case, it is only necessary to increase the dimension of the first support region 115 in the radial direction of the light guide member 11.

For example, as shown in FIG. 3 or FIG. 5, the reflective surface 111 of the light guide member 11 sequentially includes the planar region of the first support region 115 and the arc-surfaced region 114 in the direction close to a center. The first support region 115 is a planar region, and the mounting groove 113 is provided at a position on the light guide member 11 corresponding to the first support region 115.

Further, as shown in FIG. 6, the reflective surface 111 further has a second support region 116. The second support region 116 is disposed on the side of the arc-surfaced region 114 away from the first support region 115. In this case, due to the first support region 115 and the second support region 116 on two sides of the arc-surfaced region 114, the support area of the light guide member 11 on the display screen 2 may be increased, such that the stability of the light guide member 11 fixed on the display screen 2 is improved.

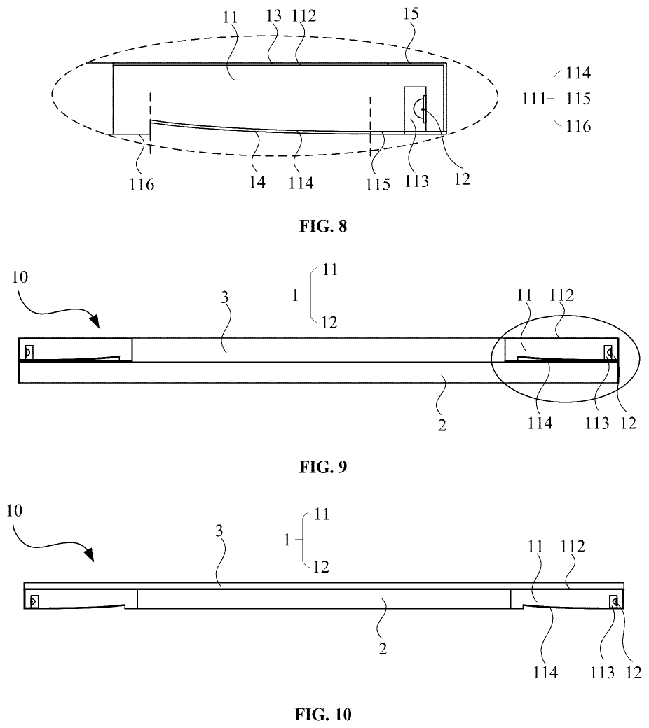

As shown in FIG. 7 and FIG. 8, the second support region 116 may be a planar structure, such that when the second support region 116 is supported on the display screen 2, the contact area between the second support region 116 and the display screen 2 is increased, and the support stability is improved.

For example, as shown in FIG. 6 or FIG. 8, the reflective surface 111 of the light guide member 11 sequentially includes the first support region 115, the arc-surfaced region 114, and the second support region 116 in the direction close to the center. Both the first support region 115 and the second support region 116 are planar regions, and the mounting groove 113 is provided at a position on the light guide member 11 corresponding to the first support region 115.

In the embodiments of the present disclosure, the mounting groove 113 is disposed on the side of the arc-surfaced region 114 close to an outer annular surface of the light guide member 11. Alternatively, the mounting groove 113 is disposed on the side of the arc-surfaced region 114 close to an inner annular surface of the light guide member 11.

The mounting groove 113 may be a ring-shaped groove, or a plurality of arc-shaped grooves distributed at intervals along the circumferential direction of the light guide member 11. The groove opening of the mounting groove 113 may be on the light-emitting surface 112 of the light guide member 11 (that is, faces away from the reflective surface 111), or may be on the reflective surface 111 of the light guide member 11 (that is, faces away from the light-emitting surface 112), as shown in FIG. 1 or FIG. 6, which is not limited in the embodiments of the present disclosure.

In the case that the groove opening of the mounting groove 113 is on the light-emitting surface 112, during assembly of the display apparatus 10 provided with the light-emitting structure 1, the light source 12 may be first mounted in the mounting groove 113 of the light guide member 11, and then, the light guide member 11 may be fixed on the display screen 2. Alternatively, the light guide member 11 is first fixed on the display screen 2, and then, the light source 12 is fixed in the mounting groove 113 of the light guide member 11.

In some embodiments, for the light source 12 in the mounting groove 113, a light-shielding layer 15 may be provided on the light-emitting surface 112 of the light guide member 11. In other words, as shown in FIG. 3 or FIG. 5, the light-emitting structure 1 further includes the light-shielding layer 15. The light-shielding layer 15 fits the light-emitting surface 112, and an orthographic projection of the light source 12 on the light-emitting surface 112 is within an orthographic projection of the light-shielding layer 15 on the light-emitting surface 112. In this case, by virtue of the light-shielding effect of the light-shielding layer 15, damage to a user's eyes caused by direct viewing of light can be avoided, and the user's viewing effect can be improved.

The material of the light-shielding layer 15 may refer to the related art, which is not limited in the embodiments of the present disclosure. For example, the light-shielding layer 15 may be acquired by spraying black paint on the light-emitting surface 112 of the light guide member 11.

With reference to the case in which the groove opening of the mounting groove 113 is on the reflective surface 111, a portion of the light-emitting surface 112 of the light guide member 11 that directly faces the mounting groove 113 is a solid portion, such that the light-shielding layer 15 can be provided directly. However, in the case that the groove opening of the mounting groove 113 is on the light-emitting surface 112, the light-emitting surface 112 of the light guide member 11 is missing at the groove opening. In this case, to avoid the arrangement of the light-shielding layer 15, a support may be provided at the groove opening of the mounting groove 113. Then, the light-shielding layer 15 is provided on the support to ensure the light-shielding effect.

Further, the light-shielding layer 15 further includes a cylindrical structure extending in the thickness direction of the light guide member 11. For the case in which the mounting groove 113 is disposed close to the outer annular surface of the light guide member 11, the cylindrical structure is sleeved on the outer annular surface of the light guiding structure, such that a light beam leaked from the outer annular surface of the light guide member 11 is blocked by the cylindrical structure. For the case in which the mounting groove 113 is close to the inner annular surface of the light guide member 11, the cylindrical structure is embedded in the ring of the light guide member 11, such that a light beam leaked from the inner annular surface of the light guide member 11 is blocked by the cylindrical structure.

In the embodiments of the present disclosure, the light source 12 may be fixed in the mounting groove 113 via an adhesive (for example, a double-sided tape) or the like. To avoid interference between the light-emitting structure 1 and another structure (for example, the display screen 2) during assembly, the light source 12 needs to be completely accommodated in the mounting groove 113. For example, the depth of the mounting groove 113 is 3.5 mm, the width of the light source 12 (namely, the dimension in the thickness direction of the light guide member 11) is 2.5 mm, the width of the mounting groove 113 (namely, the dimension in the radial direction of the light guide member 11) is 2.5 mm, and the height of the light source 12 (namely, the dimension in the radial direction of the light guide member 11) is 2 mm. Therefore, in the case that an assembling clearance of 1 mm is reserved in the depth direction of the mounting groove 113, and that an assembling clearance of 0.5 mm is reserved for the width of the mounting groove 113, it is ensured that the light source 12 can be entirely extended into the mounting groove 113.

The light source 12 may be an entire light strip or may be a plurality of light strips. To facilitate mounting of the light source 12 and reduce the production process of the light strip, the light source 12 is usually designed to include a plurality of light strips. In this way, the assembly efficiency of the light-emitting structure 1 is improved. For example, as shown in FIG. 1 or FIG. 6, the light source 12 includes four light strips distributed at intervals along the circumferential direction of the light guide member 11.

Each light strip includes a plurality of sub-light strips of different colors. For example, the light strip includes sub-light strips of three colors (R, G, and B). The sub-light strip of each color may include three parallel strings of lamp beads, and each string has 22 lamp beads. The brightness parameters of each lamp bead are shown in the following table.

| | Minimum | | Maximum | | |
|---|---|---|---|---|---|
| | value | Median | value | Unit | Loading current |
| Brightness | 72 | 100 | 225 | mcd | 20 mA |
| | 180 | 225 | 360 | | |
| | 36 | 50 | 90 | | |
| Voltage | 1.7 | 2.0 | 2.4 | V | |
| | 2.7 | 3.3 | 3.8 | | |
| | 2.7 | 3.3 | 3.8 | | |

With reference to the foregoing description, when the light guide member 11 has a structure of a circular ring, the mounting groove 113 on the light guide member 11 is a ring-shaped groove. In this case, the light source 12 is a light strip having a flexible property, such that the light strip can be mounted in the circular ring-shaped groove. When the light guide member 11 has a structure of a polygonal ring, the mounting groove 113 on the light guide member 11 is a polygonal ring-shaped groove. In this case, the light source 12 may include a plurality of straight strip-shaped light strips, and the quantity of the light strips is the same as that of the sides of the ring-shaped groove, such that the straight strip-shaped light strip can be mounted at a corresponding position on each side of the polygonal ring-shaped groove. Alternatively, the light source 12 is a light strip having a flexible property, such that a corner formed after bending the light strip can match a corner formed by two adjacent sides of the polygonal ring-shaped groove.

In addition, with reference to the above-described case in which the mounting groove 113 is a ring-shaped groove, when the light source 12 includes a plurality of light strips, optionally, as shown in FIG. 1 and FIG. 6, a plurality of partitions 117 may be disposed in the ring-shaped groove, and one light strip is arranged between two adjacent partitions 117. In this case, due to the arrangement of the partition 117, separation of two light strips is achieved, such that two adjacent light strips are prevented from having an overlapping region in the circumferential direction of the light guide member 11. Otherwise, such an overlapping area would cause a partial region to be too bright, resulting in uneven brightness of the light-emitting structure 1.

Alternatively, for the case in which the mounting groove 113 includes a plurality of arc-shaped grooves, the light source 12 includes a plurality of light strips in one-to-one correspondence with the arc-shaped grooves, and each light strip is fixed in a corresponding arc-shaped groove. In this case, the plurality of light strips are separated by the arc-shaped grooves, such that two adjacent light strips are prevented from having an overlapping region in the circumferential direction of the light guide member 11. Otherwise, such an overlapping area would cause a partial region to be too bright, resulting in uneven brightness of the light-emitting structure 1.

FIG. 9 illustrates a schematic structural diagram of a display apparatus 10 according to some embodiments of the present disclosure. As shown in FIG. 9, the display apparatus 10 includes: a display screen 2 and the light-emitting structure 1 according to the foregoing embodiments. The display screen 2 is disposed on a side of the light guide member 11 close to the reflective surface 111.

In this case, for the display apparatus 10 including the above-described light-emitting structure 1, due to self-illumination of the light-emitting structure 1, the brightness of the display screen 2 when displaying an image is ensured. Therefore, a case where the displayed image is relatively dark is avoided, thereby improving the display effect of the display apparatus 10.

Alternatively, in addition to being disposed on the side of the light-emitting structure 1 close to the reflective surface, the display screen 2 may be disposed, as shown in FIG. 10, in a region encircled by the light guide member 11 included in the light-emitting structure 1.

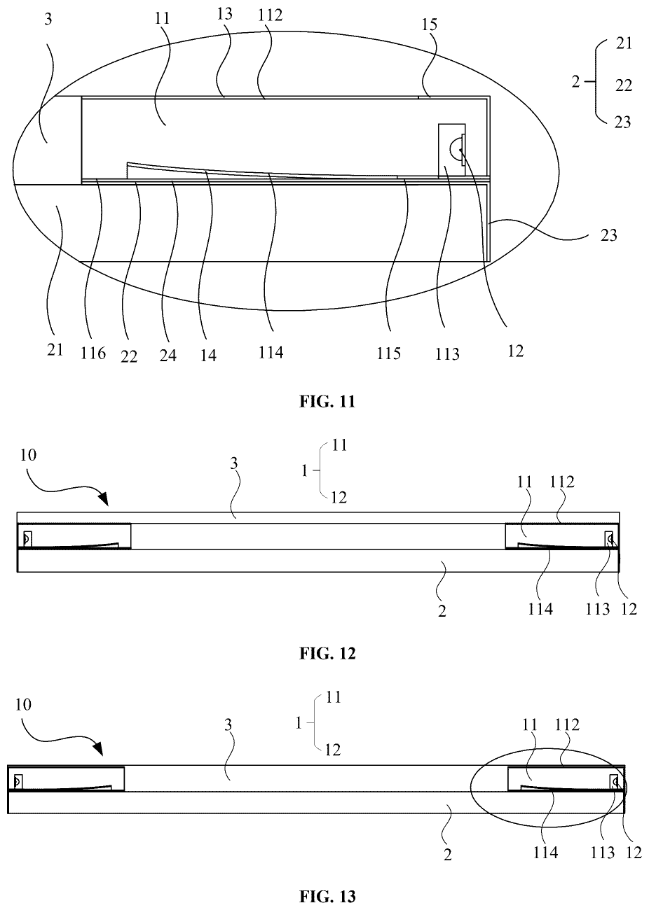

As shown in FIG. 11, the display screen 2 includes a display module 21, a top bezel 22, and a side bezel 23. The top bezel 22 has a ring-shaped structure; the top bezel 22 fits the reflective surface 111 side of the light guide member; the side bezel 23 has a cylindrical structure and is fixedly connected to an edge of the top bezel 22, and the display module 21 is disposed in a region encircled by the side bezel 23.

The top bezel 22 and the side bezel 23 are of an integral structure, to reduce the quantity of components included in the display screen 2, thereby improving the assembly efficiency of the display screen 2. Moreover, the stability of the connection between the top bezel 22 and the side bezel 23 is improved.

Optionally, as shown in FIG. 11, the surface of the top bezel 22 facing the light guide member is provided with a second reflection layer 24. Due to the arrangement of the second reflection layer 24, a light beam leaked from the reflective surface 111 of the light guide member 11 continues to be incident on the light guide member 11 under the reflection of the second reflection layer, to improve the utilization efficiency of the light beam.

In some embodiments, the display apparatus 10 further includes a glass cover plate 3. As shown in FIG. 9, the glass cover plate 3 is disposed in a region encircled by the light guide member 11. Alternatively, as shown in FIG. 10, FIG. 12, or FIG. 13, the glass cover plate 3 is supported on the light-emitting structure 1. However, when the glass cover plate 3 is supported on the light-emitting structure 1, as shown in FIG. 13 and FIG. 14, the glass cover plate 3 has a protrusion 31 and a step surface 32 forming the protrusion 31. The protrusion 31 is disposed in a region encircled by the light guide member 11, and the step surface 32 is supported on the light-emitting structure 1 (the diffuser film 13).

Moreover, when the glass cover plate 3 is disposed in the region encircled by the light guide member 11, the problem that the thickness of the display apparatus 10 is increased by adding the light guide member 11 is avoided. Therefore, ultra-thinning of the display apparatus 10 is facilitated.

Optionally, the reflectivity of the glass cover plate 3 is greater than or equal to 30% and less than or equal to 70%, which ensures that the glass cover plate 3 can achieve a mirror effect based on the reflectivity, that is, the display apparatus 10 can display a screen normally, and achieve the mirror effect when no image is displayed. Therefore, the applicability of the display apparatus 10 is improved.

In addition, when the glass cover plate 3 is supported on the light-emitting structure 1, the surface area of the glass cover plate 3 is increased, such that the display apparatus 10 has a larger mirror area, which helps improve the mirror effect.

AG/AR processing may be performed on the glass cover plate 3, to ensure that the reflectivity of the glass cover plate 3 is greater than or equal to 30% and less than or equal to 70%. For example, the reflectivity of the glass cover plate 3 is 30%, 50%, or 70%. Optionally, the reflectivity of the glass cover plate 3 is 50%. In this case, the light transmittance of the glass cover plate 3 is 50%. Therefore, the display effect of the display apparatus 10 when displaying an image and the mirror effect of the display apparatus when used as a mirror are ensured.

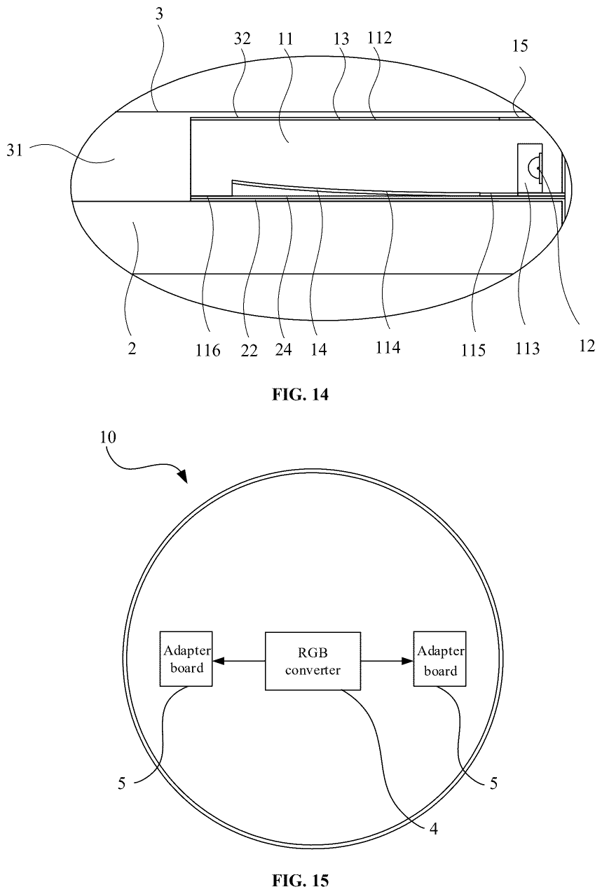

In some embodiments, as shown in FIG. 15, the display apparatus 10 further includes an RGB converter 4 and an adapter board 5. The RGB converter 4 is electrically connected to the adapter board 5, and is electrically connected to the display screen; the adapter board 5 is electrically connected to the light source 12. The RGB converter 4 is configured to acquire display information of the display screen and determine corresponding RGB information based on the display information. The adapter board 5 is configured to acquire the RGB information, determine a corresponding electrical parameter based on the RGB information, and control the light source 12 to emit light based on the electrical parameter.

In this case, the connection between the display screen and the light source 12 is realized by using the RGB converter 4 and the adapter board 5, such that the emission colors of the light source 12 can change with images displayed on the display screen 2. Therefore, the display area of the display apparatus 10 is visually increased to improve the display effect.

The light source 12 is connected to a flexible circuit board. With reference to the foregoing description, the top bezel 22 of the display screen 2 is provided with a through hole. A free end of the flexible circuit board (the end not connected to the light source) passes through the through hole in the top bezel 22 and is electrically connected to the adapter board 5.

When the light source 12 includes a plurality of light strips, the display apparatus 10 includes a plurality of adapter boards 5. The plurality of adapter boards 5 are in one-to-one correspondence with the plurality of light strips, and each light strip is electrically connected to a corresponding adapter board 5. Each adapter board 5 is electrically connected to the RGB converter 4.

The details about related structures of the RGB converter 4 and the adapter board 5, reference may be made to the related art, which is not limited in the embodiments of the present disclosure.

The embodiments of the present disclosure provide a schematic flowchart of a control method for a display apparatus. The control method is applied to the above-described display apparatus.

The control method includes: acquiring display information of the display screen, and adjusting the color of the light source of the light-emitting structure based on the display information. In this way, while increasing the brightness of an image displayed by the display apparatus, the display area of the display apparatus is visually increased to improve the display effect.

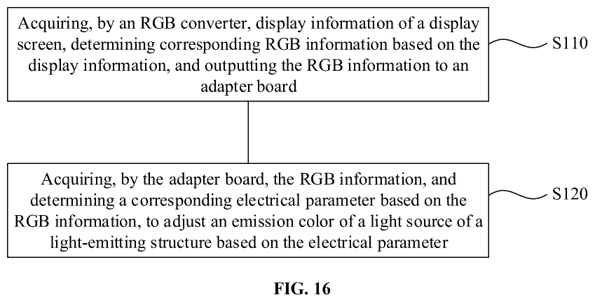

In some embodiments, the foregoing method is applied to the display apparatus including the RGB converter and the adapter board. As shown in FIG. 16, the control method includes the following steps S110 to S120.

In step S110, an RGB converter acquires display information of a display screen, determines corresponding RGB information based on the display information, and outputs the RGB information to the adapter board.

In step S120, the adapter board acquires the RGB information, and determines a corresponding electrical parameter based on the RGB information, to adjust an emission color of a light source of a light-emitting structure based on the electrical parameter.

In the embodiments of the present disclosure, when the display screen displays an image, the RGB converter may acquire display information of the displayed image, and convert colors in the display information into RGB information (the conversion method may refer to the related art); and then, the adapter board determines, based on the RGB information, electrical parameters respectively corresponding to R, G and B information. Furthermore, the emission color of the light source is controlled, such that emission colors of the light source of the light-emitting structure can change with images displayed on the display screen. Therefore, the display area of the display apparatus is visually increased to improve the display effect.

In the foregoing step S110, for the display information of the display screen, the RGB converter may determine the corresponding RGB information based only on display information at an edge position of the displayed image, to ensure that the emission color of the light-emitting structure is easier to be spliced with the color of the displayed image, thereby improving the visual display effect of the display apparatus.

Those skilled in the art may readily conceive of other embodiments of the present disclosure after considering the specification and practicing the present disclosure disclosed herein. The present disclosure is intended to cover any variations, uses, or adaptive changes of the present disclosure, which follow the general principle of the present disclosure and include common knowledge or conventional technical means in the technical field disclosed by the present disclosure. The specification and embodiments are merely considered as illustrative, and the true scope and spirit of the present disclosure are indicated by the appended claims.

1. A light-emitting structure, comprising:
a light guide member, wherein the light guide member is ring-shaped and has a light-emitting surface and a reflective surface that are opposite to each other in a thickness direction, the reflective surface having an arc-surfaced region; the light guide member is further provided with a mounting groove that is on one side of the arc-surfaced region in a radial direction of the light guide member and extends in a circumferential direction of the light guide member; and a thickness of the light guide member in the arc-surfaced region decreases progressively in a direction away from the mounting groove; and
a light source, disposed in the mounting groove, wherein a light-emitting side of the light source faces the arc-surfaced region.

2. The light-emitting structure according to claim 1, wherein the reflective surface further has a planar region on one side of the arc-surfaced region close to the mounting groove, the planar region and the arc-surfaced region being continuous in the radial direction of the light guide member.

3. The light-emitting structure according to claim 1, wherein the reflective surface has a first support region that is on the side of the arc-surfaced region in the radial direction of the light guide member, and the mounting groove is provided at a position of the light guide member corresponding to the first support region.

4. The light-emitting structure according to claim 3, wherein the reflective surface has a second support region, the second support region being disposed on one side of the arc-surfaced region away from the first support region.

5. The light-emitting structure according to claim 1, wherein the mounting groove is disposed on one side of the arc-surfaced region close to an outer annular surface of the light guide member.

6. The light-emitting structure according to claim 1, wherein a groove opening of the mounting groove faces away from the light-emitting surface; and the light-emitting structure further comprises a light-shielding layer, the light-shielding layer being attached to the light-emitting surface, and an orthographic projection of the light source on the light-emitting surface being within an orthographic projection of the light-shielding layer on the light-emitting surface.

7. The light-emitting structure according to claim 1, wherein the light source comprises at least one light strip, the light strip comprising sub-light strips in three colors: red, green, and blue.

8. The light-emitting structure according to claim 1, wherein the mounting groove is a ring-shaped groove, and a plurality of partitions are arranged at intervals in the ring-shaped groove; and the light source comprises a plurality of light strips, one of the plurality of light strips is provided between every two adjacent partitions.

9. The light-emitting structure according to claim 1, wherein the mounting groove comprises a plurality of arc-shaped grooves arranged at intervals along the circumferential direction of the light guide member; and the light source comprises a plurality of light strips in one-to-one correspondence with the arc-shaped grooves; wherein each of the plurality of light strips is fixed in a corresponding arc-shaped groove.

10. The light-emitting structure according to claim 1, wherein the light-emitting structure further comprises a diffuser film, the diffuser film being attached to the light-emitting surface.

11. The light-emitting structure according to claim 1, further comprising a first reflection layer, wherein the first reflection layer is attached to the reflective surface of the light guide member, and an orthographic projection of the first reflection layer on the reflective surface of the light guide member covers the arc-surfaced region.

12. A display apparatus, comprising: a display screen and a light-emitting structure, wherein the display screen is disposed on one side of the light guide member close to the reflective surface; and
the light-emitting structure comprises:
a light guide member, wherein the light guide member is ring-shaped and has a light-emitting surface and a reflective surface that are opposite to each other in a thickness direction, the reflective surface having an arc-surfaced region; the light guide member is further provided with a mounting groove that is on one side of the arc-surfaced region in a radial direction of the light guide member and extends in a circumferential direction of the light guide member; and a thickness of the light guide member in the arc-surfaced region decreases progressively in a direction away from the mounting groove; and
a light source, disposed in the mounting groove, wherein a light-emitting side of the light source faces the arc-surfaced region.

13. The display apparatus according to claim 12, further comprising a glass cover plate, the glass cover plate being disposed in a region encircled by the light guide member.

14. The display apparatus according to claim 12, further comprising a glass cover plate, wherein the glass cover plate is provided with a protrusion and a step surface forming the protrusion, the protrusion being disposed in a region encircled by the light guide member, and the step surface being supported on the light-emitting structure.

15. The display apparatus according to claim 12, wherein the display screen comprises a display module, a top bezel, and a side bezel; wherein
the top bezel has a ring-shaped structure and is disposed on a side where the reflective surface side of the light guide member is located, and a surface of the top bezel facing the light guide member is provided with a second reflection layer; the side bezel has a cylindrical structure and is fixedly connected to an edge of the top bezel; and the display module is disposed in a region encircled by the side bezel.

16. The display apparatus according to claim 15, wherein a reflectivity of the glass cover plate is greater than or equal to 30% and less than or equal to 70%.

17. The display apparatus according to claim 12, further comprising an RGB converter and an adapter board, wherein
the RGB converter is electrically connected to the adapter board and is electrically connected to the display screen, and the adapter board is electrically connected to the light source; and
the RGB converter is configured to acquire display information of the display screen, and determine corresponding RGB information based on the display information, and the adapter board is configured to acquire the RGB information, determine a corresponding electrical parameter based on the RGB information, and control the light source to emit light based on the electrical parameter.

18. A control method for a display apparatus, applied to the display apparatus as defined in claim 12, and comprising:
acquiring display information of the display screen, and
adjusting an emission color of the light source of the light-emitting structure based on the display information.

19. A control method for a display apparatus, applied to the display apparatus as defined in claim 17, and comprising:
acquiring, by the RGB converter, the display information, determining the corresponding RGB information based on the display information, and outputting the RGB information to the adapter board; and
acquiring, by the adapter board, the RGB information, and determining the corresponding electrical parameter based on the RGB information, to adjust the emission color of the light source of the light-emitting structure based on the electrical parameter.
